(19) United States
(12) Patent Application Publication
(10) Pub. No.: US 2021/0318819 A1
(43) Pub. Date: Oct. 14, 2021

(54) DATA PROCESSING SYSTEM

(71) Applicant: SK hynix Inc., Icheon (KR)

(72) Inventors: Yun Jeong MUN, Icheon (KR); Eui Cheol LIM, Icheon (KR); Mi Seon HAN, Icheon (KR); Myoung Seo KIM, Icheon (KR)

(21) Appl. No.: 17/009,680

(22) Filed: Sep. 1, 2020

(30) Foreign Application Priority Data
Apr. 13, 2020 (KR) 10-2020-0044618

(51) Int. Cl. G06F 3/06

(52) U.S. Cl. CPC G06F 3/0631; G06F 3/0646; G06F 3/0688; G06F 3/0653; G06F 3/0604; G06F 3/0659

(57) ABSTRACT

A data processing system includes a plurality of processors, a memory, a non-volatile memory, and a memory controller. The operational memory includes a first memory region and a second memory region. The memory controller performs a first swap operation of releasing assignment of a memory area assigned to a first processor within the first memory region, the first swap operation performed by moving data from the memory area to the second memory region. The memory controller performs a second swap operation by moving the data from the second memory region to the non-volatile memory when a second swap condition is satisfied after completion of the first swap operation.

### CROSS-REFERENCES TO RELATED APPLICATION

The present application claims priority under 35 U.S.C. § 119(a) to Korean application number 10-2020-0044618, filed on Apr. 13, 2020, in the Korean Intellectual Property Office, which is incorporated herein by reference in its entirety as set forth in full.

### BACKGROUND

### 1. Technical Field

Various embodiments are related to a data processing system, and more particularly, to a data processing system including a memory device.

### 2. Related Art

A data processing system may use a pooled memory in order to effectively process a large amount of data. A pooled memory may have a high memory capacity and a high bandwidth.

A pooled memory may include a plurality of memories. The pooled memory may not be dedicated to a single processor but may be shared by a plurality of processors. Therefore, it is important to appropriately assign a memory and release the assignment of the memory for each of the processors in the plurality of processors in order to meet memory needs of the respective processors. When the memory is not appropriately assigned and the assignment of the memory is not properly released, there may occur performance degradation of workload in a processor, due to lack of memory, and resource dissipation may occur in an idle processor, for which the assignment of memory is not released.

Before releasing the assignment of a memory, data stored in the memory must be moved to another memory region. Performance degradation may occur when the data is not promptly moved.

### SUMMARY

Various embodiments of the present disclosure provide a data processing system capable of effectively assigning memories to a plurality of processors and swiftly releasing assignments of the memories.

In accordance with an embodiment, a data processing system may include a plurality of processors, a memory, a non-volatile memory, and a memory controller. The memory may include a first memory region and a second memory region. The memory controller may perform a first swap operation of releasing assignment of a memory area assigned to a first processor within the first memory region, the first swap operation performed by moving data from the memory area to the second memory region. The memory controller may perform a second swap operation by moving the data from the second memory region to the non-volatile memory when a second swap condition is satisfied after completion of the first swap operation.

In accordance with an embodiment, a data processing system may include a plurality of processors, an operational memory including a first memory region and a second memory region, and a memory controller. The operational memory may include a first memory region and a second memory region. The memory controller may perform a first swap operation of releasing assignment of a memory area assigned to a first processor within the first memory region, the first swap operation performed by compressing data stored in the memory area and storing the compressed data into the second memory region.

In accordance with an embodiment, a data processing system may include a plurality of processors, a memory, a non-volatile memory, and a memory controller. The operational memory may include a first memory region and a second memory region. The memory controller may perform, according to a first mode swap condition, a first mode swap operation or a second mode swap operation for releasing assignment of a memory area assigned to a first processor within the first memory region. The memory controller may perform the second mode swap operation by temporarily moving data from the memory area to the second memory region and moving the data from the second memory region to the non-volatile memory. The memory controller may perform the first mode swap operation by moving the data from the memory area to the non-volatile memory without using the second memory region.

In accordance with an embodiment, the data processing system may effectively assign memories to the plurality of processors and swiftly release assignments of the memories.

### BRIEF DESCRIPTION OF THE DRAWINGS

Features, aspects and embodiments are described in conjunction with the attached drawings, in which:

FIG. 1 shows a data processing system in accordance with an embodiment;

FIG. 2 shows an operation that a memory controller of FIG. 1 assigns a first memory region to processors, in accordance with an embodiment;

FIG. 3 shows a table through which a memory controller manages memory usage ratios of processors, in accordance with an embodiment;

FIGS. 4A and 4B show first and second swap operations that a memory controller of FIG. 1 performs, in accordance with an embodiment;

FIG. 5 shows a swap operation that a memory controller of FIG. 1 performs, in accordance with an embodiment;

FIG. 6 shows an operation that a memory controller of FIG. 1 adjusts memory capacities assigned to processors, in accordance with an embodiment;

FIG. 7 shows an operation that a memory controller of FIG. 1 releases assignment of a swap memory area, in accordance with an embodiment; and

FIG. 8 shows an operation that a memory controller of FIG. 1 releases assignment of a swap memory area, in accordance with an embodiment.

### DETAILED DESCRIPTION

Exemplary embodiments will be described below in more detail with reference to the accompanying drawings. The embodiments may, however, be implemented in different forms and should not be construed as being limited to the embodiments set forth herein. Rather, these embodiments are provided so that this disclosure will be thorough and complete, and will fully convey the scope of the present disclosure to those skilled in the art.

The drawings are not necessarily to scale and, in some instances, proportions may have been exaggerated in order to clearly illustrate features of the embodiments. The terminology used herein is for the purpose of describing particular embodiments only and is not intended to be limiting of the invention.

As used herein, the term “and/or” includes at least one of the associated listed items. It will be understood that when an element is referred to as being “connected to”, or “coupled to” another element, it may be directly on, connected to, or coupled to the other element, or one or more intervening elements may be present. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements.

Hereinafter, exemplary embodiments of the present disclosure will be described below with reference to the accompanying drawings.

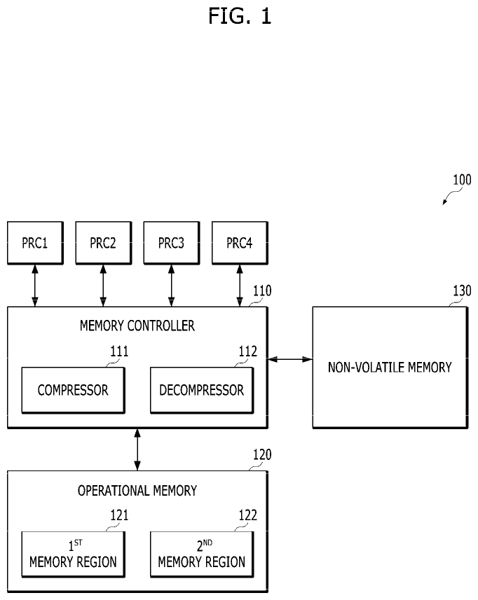

FIG. 1 shows a data processing system 100 in accordance with an embodiment.

Referring to FIG. 1, the data processing system 100 may be an electronic system capable of processing data. The data processing system 100 may include a datacenter, an internet datacenter, a cloud datacenter, a personal computer, a laptop computer, a smartphone, a tablet computer, a digital camera, a game console, a navigation, a virtual reality device, a wearable device, and so forth.

The data processing system 100 may include processors PRC1 to PRC4, a memory controller 110, and a non-volatile memory 130.

Each of the processors PRC1 to PRC4 may process a workload by using an assigned memory area from a first memory region 121 within an operational memory 120 (e.g., a memory device such as DRAM). Each of the processors PRC1 to PRC4 may include a central processing unit, a graphic processing unit, a micro-processor, an application processor, an accelerated processing unit, an operating system, and so forth. The number of processors included in the data processing system 100 may depend on an embodiment. In an embodiment, the processors may be hardware processors such as CPUs, GPUs, DSPs, or the like, or cores thereof.

The memory controller 110 may divide the first memory region 121 into memory areas and assign the memory areas to the respective processors PRC1 to PRC4. For example, the memory controller 110 may divide the first memory region 121 into four memory areas and assign the four memory areas to the respective processors PRC1 to PRC4.

The memory controller 110 may adjust capacities of the memory areas assigned to the respective processors PRC1 to PRC4 within the first memory region 121 based on memory usage ratios of the processors PRC1 to PRC4.

Particularly, the memory controller 110 may determine memory usage ratios of the respective processors PRC1 to PRC4 based on information of memory usage amounts received from the respective processors PRC1 to PRC4, memory capacities assigned to the respective processors PRC1 to PRC4 within the first memory region 121, and internal memory capacities included in the respective processors PRC1 to PRC4. Based on the determined memory usage ratios, the memory controller 110 may increase a memory capacity for a processor when an assigned memory capacity of the processor is determined to be insufficient and may decrease a memory capacity for a processor when an assigned memory capacity of the processor is determined to be excessive.

When decreasing a memory capacity assigned to a processor, the memory controller 110 may release the assignment of a part or a whole of the memory area assigned to the processor within the first memory region 121. In order to release the assignment of a memory area assigned to a processor, the memory controller 110 may perform a first swap operation and a second swap operation on data stored in the memory area (hereinafter, referred to as a swap memory area).

Particularly, the memory controller 110 may perform a first swap operation of moving data from a swap memory area of the first memory region 121 to a second memory region 122. The memory controller 110 may perform the first swap operation by compressing data stored in the swap memory area and storing the compressed data in the second memory region 122. After completion of the first swap operation, the memory controller 110 may release the assignment of the swap memory area.

In an embodiment, the memory controller 110 may perform a second swap operation of moving data from the second memory region 122 to the non-volatile memory 130. The memory controller 110 may perform the second swap operation by decompressing the compressed data stored in the second memory region 122 and storing the decompressed data in the non-volatile memory 130.

In an embodiment, the memory controller 110 may perform the second swap operation when a second swap condition is satisfied after completion of the first swap operation. For example, the memory controller 110 may determine the second swap condition to be satisfied when the memory controller 110 determines to expand the first memory region 121 by incorporating the second memory region 122 into the first memory region 121. For example, the memory controller 110 may determine the second swap condition to be satisfied when a resource required for the second swap operation is sufficient.

In summary, the memory controller 110 may temporarily move data from a swap memory area of the first memory region 121 to the second memory region 122 through the first swap operation and may finally move the data from the second memory region 122 to the non-volatile memory 130 through the second swap operation. Even before performing the second swap operation, the memory controller 110 may release the assignment of the swap memory area when the first swap operation is completed.

In an embodiment, the memory controller 110 may perform a first mode swap operation or a second mode swap operation on a swap memory area depending on a first mode swap condition, as described later.

For example, the memory controller 110 may determine the first mode swap condition to be satisfied when a memory capacity available to be used as the second memory region 122 becomes insufficient within the operational memory 120. For example, the memory controller 110 may determine the first mode swap condition to be satisfied when a resource required for the first mode swap operation is sufficient.

The memory controller 110 may perform the first mode swap operation when the first mode swap condition is satisfied. The memory controller 110 may perform the first mode swap operation of moving data from a swap memory area of the first memory region 121 to the non-volatile memory 130. That is, the memory controller 110 may perform the first mode swap operation of moving data from the swap memory area directly to the non-volatile memory 130 without via the second memory region 122. After completion of the first mode swap operation, the memory controller 110 may release the assignment of the swap memory area.

When the first mode swap condition is not satisfied, the memory controller 110 may perform the second mode swap operation. The memory controller 110 may perform the second mode swap operation of temporarily moving data from a swap memory area of the first memory region 121 to the second memory region 122 and finally moving the data from the second memory region 122 to the non-volatile memory 130. That is, the second mode swap operation may include the first swap operation and the second swap operation. The memory controller 110 may complete the second mode swap operation by performing the second swap operation when the second swap condition is satisfied after completion of the first swap operation. Before performing the second swap operation, the memory controller 110 may release the assignment of the swap memory area when the first swap operation is completed.

The memory controller 110 may include a compressor 111 configured to compress data and a decompressor 112 configured to decompress compressed data.

The operational memory 120 may be shared by the processors PRC1 to PRC4 according to the described method. For example, the operational memory 120 may be a pooled memory. The pooled memory may include a plurality of memories and thus may have a high memory capacity and a high bandwidth.

In an embodiment, the operational memory 120 may include a volatile memory apparatus such as Dynamic Random Access Memory (DRAM), Static Random Access Memory (SRAM), and so forth.

In an embodiment, the operational memory 120 may include a non-volatile memory apparatus such as a flash memory device (e.g., NAND Flash or NOR Flash), a Ferroelectrics Random Access Memory (FeRAM) device, a Phase-Change Random Access Memory (PCRAM) device, a Magnetic Random Access Memory (MRAM) device, a Resistive Random Access Memory (ReRAM) device, and so forth.

The operational memory 120 may operate with a greater access speed than the non-volatile memory 130.

The operational memory 120 may include the first memory region 121 and the second memory region 122.

The first memory region 121 may be divided into memory areas to be assigned to the processors PRC1 to PRC4 according to a control of the memory controller 110.

The second memory region 122 may be utilized as a temporary swap memory of the first memory region 121 according to a control of the memory controller 110. When the memory controller 110 incorporates all of the second memory region 122 into the first memory region 121, the operational memory 120 may then include only the first memory region 121.

The non-volatile memory 130 may securely retain stored data even when power supplied thereto is interrupted. Therefore, the non-volatile memory 130 may be utilized as a swap memory of the operational memory 120. That is, data stored in the operational memory 120 may be moved (i.e., swapped) to the non-volatile memory 130 according to control of the memory controller 110.

In an embodiment, the non-volatile memory 130 may include a memory system such as a Personal Computer Memory Card International Association (PCMCIA) card, a Compact Flash (CF) card, a smart media card, a memory stick, any of various types of multimedia cards (MMC, eMMC, RS-MMC and MMC-micro), a Secure Digital (SD) card (SD, Mini-SD and Micro-SD), a Universal Flash Storage (UFS) device, a Solid State Drive (SSD), and so forth.

In an embodiment, the non-volatile memory 130 may include a non-volatile memory apparatus such as a flash memory device (e.g., NAND Flash or NOR Flash), a FeRAM device, a PCRAM device, an MRAM device, a ReRAM device, and so forth.

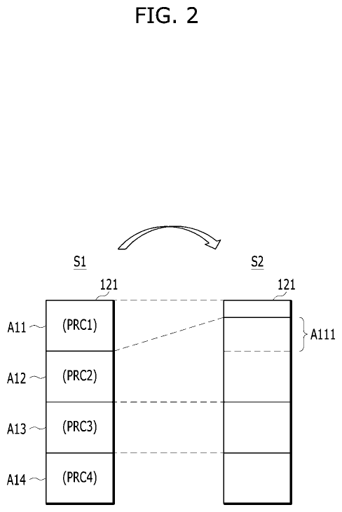

FIG. 2 shows an operation by which the memory controller 110 of FIG. 1 assigns the first memory region 121 to the processors PRC1 to PRC4, in accordance with an embodiment.

Referring to FIG. 2, in step S1, the memory controller 110 may divide the first memory region 121 into memory areas A11 to A14 within the operational memory 120 and may assign the memory areas A11 to A14 to the respective processors PRC1 to PRC4. Step S1 may be performed when the data processing system 100 boots. For example, the memory areas A11 to A14 may all have the same memory capacity. In another embodiment, the memory areas A11 to A14 may have different memory capacities.

In step S2, the memory controller 110 may adjust the memory capacities assigned to the respective processors PRC1 to PRC4. For example, the memory controller 110 may decrease the memory capacity assigned to the processor PRC1 and may increase the memory capacity assigned to the processor PRC2. For example, assignment of a memory area A111 within the memory area A11 assigned to the processor PRC1 may be released and the memory area A111 may be assigned to the processor PRC2, as illustrated in FIG. 2.

In order to determine whether to adjust the memory capacities assigned to the respective processors PRC1 to PRC4, the memory controller 110 may refer to memory usage ratios of the respective processors PRC1 to PRC4. The memory controller 110 may determine a memory usage ratio of each of the processors PRC1 to PRC4 based on the following equation E1.

MEMORY USAGE RATIO=MEMORY USAGE AMOUNT/AVAILABLE MEMORY CAPACITY. Equation E1

In equation E1, the memory usage amount may be an amount of memory that is actually being used by the corresponding processor. For example, the respective processors PRC1 to PRC4 may determine memory usage amounts thereof by referring to the Hardware Performance Counter (HPC) thereof and may inform the memory controller 110 of the determined memory usage amounts. In an embodiment, the respective processors PRC1 to PRC4 may periodically inform the memory controller 110 of the determined memory usage amounts thereof, respectively. In another embodiment, the respective processors PRC1 to PRC4 may inform the memory controller 110 of the determined memory usage amounts thereof in response to requests from the memory controller 110.

In equation E1, the available memory capacity may be the memory capacity available for the corresponding processor (all memory that is in use and all memory that is not in use). The available memory capacity may include a memory capacity assigned to the corresponding processor within the first memory region 121 of the operational memory 120. In an embodiment, the available memory capacity may further include an internal memory capacity included in the corresponding processor.

The memory usage amounts of the respective processors PRC1 to PRC4 may change according to the progressions of workloads of the respective processors PRC1 to PRC4. Therefore, the memory usage ratios of the respective processors PRC1 to PRC4 may change. The memory controller 110 may repeatedly adjust the memory capacities assigned to the respective processors PRC1 to PRC4 according to the changes of the memory usage ratios of the respective processors PRC1 to PRC4. For example, even after step S2, the memory controller 110 may repeatedly adjust the memory capacities assigned to the respective processors PRC1 to PRC4.

The memory controller 110 may compare each of the memory usage ratios of the processors PRC1 to PRC4 with a predetermined threshold value to determine whether to adjust the memory capacities assigned to the respective processors PRC1 to PRC4. For example, the memory controller 110 may determine to increase the memory capacity assigned to a processor when the memory usage ratio of the processor becomes greater than a first threshold value. For example, the memory controller 110 may determine to decrease the memory capacity assigned to a processor when the memory usage ratio of the processor becomes less than a second threshold value. The first threshold value may be the same as, or different from, the second threshold value. An increment or a decrement of the memory capacity may depend on the memory usage ratio and may be a predetermined amount of memory.

In an embodiment, when increasing the memory capacities assigned to multiple processors, the memory controller 110 may assign a greater memory capacity to a processor of a greater memory usage ratio among the multiple processors.

In an embodiment, the memory controller 110 may adjust the memory capacities assigned to the respective processors PRC1 to PRC4 by utilizing the buddy algorithm.

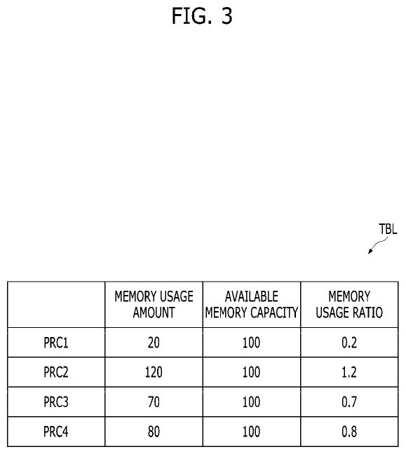

FIG. 3 shows a table TBL, with which the memory controller 110 manages the memory usage ratios of the processors PRC1 to PRC4, in accordance with an embodiment.

Referring to FIG. 3, the table TBL may include the memory usage amounts, the available memory capacities, and the memory usage ratios of the respective processors PRC1 to PRC4. The memory usage ratio of a processor may be obtained through equation E1 and based on the memory usage amount and the available memory capacity of the processor. The example numerals illustrated in FIG. 3 may be values of a predetermined unit regarding a memory capacity.

Referring to the table TBL, the memory controller 110 may determine that the memory usage ratio of the processor PRC1 is less than the second threshold value and thus may determine to decrease the memory capacity assigned to the processor PRC1. The memory controller 110 may determine that the memory usage ratio of the processor PRC2 is greater than the first threshold value and thus may determine to increase the memory capacity assigned to the processor PRC2. The memory controller 110 may determine that the memory usage ratios of the respective processors PRC3 and PRC4 are between the second threshold value and the first threshold value and thus may determine to not adjust the memory capacities assigned to the respective processors PRC3 and PRC4.

Whenever any of the memory usage amounts or any of the available memory capacities change, the memory controller 110 may update a corresponding value in the table TBL and a corresponding memory usage ratio according to the updated memory usage amount or memory capacity.

The table TBL may be stored in an internal memory (not illustrated) included in the memory controller 110.

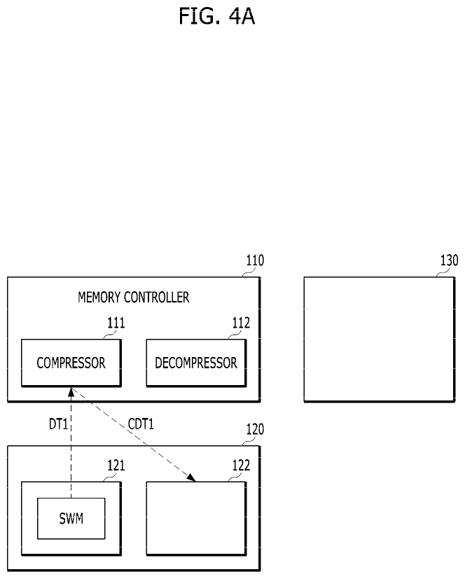

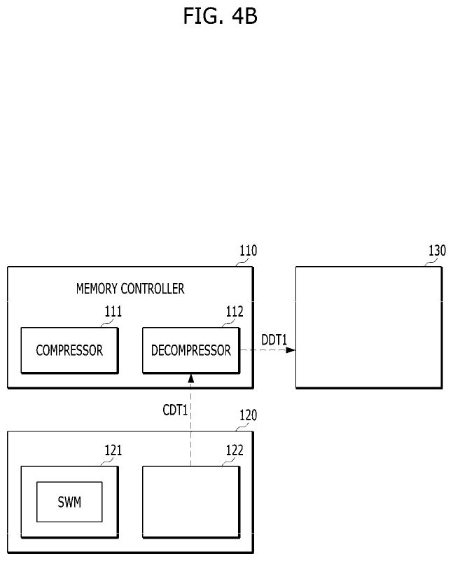

FIGS. 4A and 4B show the first and second swap operations that the memory controller 110 of FIG. 1 performs, in accordance with an embodiment.

Referring to FIG. 4A, when the memory controller 110 determines to decrease the memory capacity assigned to the processor PRC1 for example, the memory controller 110 may determine, as the swap memory area SWM, the memory area (e.g., the memory area A111 illustrated in FIG. 2) assigned to the processor PRC1 within the first memory region 121. For example, when data stored in a memory area is cold data, the memory controller 110 may determine the memory area as the swap memory area SWM.

The memory controller 110 may perform the first swap operation to move data from the swap memory area SWM to the second memory region 122. The memory controller 110 may read data DT1 from the swap memory area SWM, may compress the read data DT1 through the compressor 111 and may store the compressed data CDT1 into the second memory region 122. After completion of the first swap operation, the memory controller 110 may release the assignment of the swap memory area SWM.

Referring to FIG. 4B, when the second swap condition is satisfied, the memory controller 110 may perform the second swap operation of moving data from the second memory region 122 to the non-volatile memory 130. The memory controller 110 may read the compressed data CDT1 from the second memory region 122, may decompress the compressed data CDT1 through the decompressor 112, and may store the decompressed data DDT1 into the non-volatile memory 130.

For example, the second swap condition for performing the second swap operation may be satisfied when the memory controller 110 determines to expand the first memory region 121. When all the memory usage ratios of the respective processors PRC1 to PRC4 are high and thus the memory capacities assigned to the respective processors PRC1 to PRC4 are insufficient, the second memory region 122 may be incorporated into the first memory region 121 after completion of the second swap operation.

For example, the second swap condition for performing the second swap operation may be satisfied when a resource required for the second swap operation is sufficient, e.g., when a transmission network between the operational memory 120 and the non-volatile memory 130 is sufficient. For example, It may be determined that the transmission network is sufficient when the transmission network is not in use to perform other operations and/or when other operations to be performed by using the transport network are not waiting. In other words, when a performance degradation of the data processing system 100 does not occur, data may be permanently retained through the second swap operation.

The memory controller 110 may perform the second swap operation of moving, all at once, to the non-volatile memory 130, the compressed data that has been cumulatively stored in the second memory region 122 through multiple first swap operations.

In summary, the non-volatile memory 130 may have a lower access speed than the operational memory 120. Therefore, a swap operation performed on the non-volatile memory 130 at each release of the assignment of the swap memory area SWM within the first memory region 121 may affect overall performance of the data processing system 100. In accordance with an embodiment, the temporary moving of the compressed data to the second memory region 122 may cause a number of accesses to the non-volatile memory 130 to be reduced and thus may prevent performance degradation of the data processing system 100.

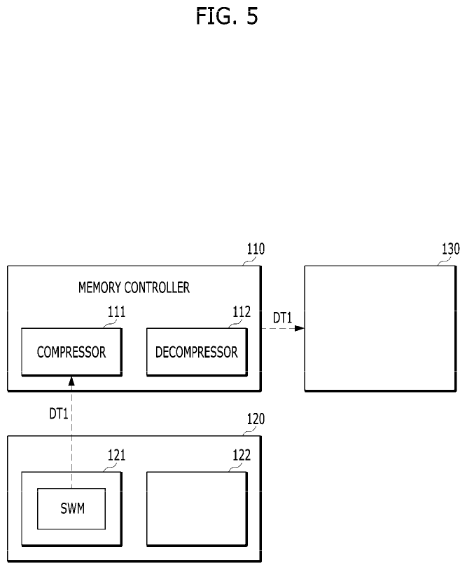

FIG. 5 shows a swap operation that the memory controller 110 of FIG. 1 performs, in accordance with an embodiment.

Referring to FIG. 5, when the first mode swap condition is satisfied, the memory controller 110 may perform the first mode swap operation to move data from the swap memory area SWM assigned to the processor PRC1 (within the first memory region 121) to the non-volatile memory 130. The memory controller 110 may perform the first mode swap operation of reading the data DT1 from the swap memory area SWM and directly storing the read data DT1 into the non-volatile memory 130. The data DT1 may not go through the second memory region 122 during the first mode swap operation. After completion of the first mode swap operation, the memory controller 110 may release the assignment of the swap memory area SWM.

For example, the first mode swap condition for performing the first mode swap operation may be satisfied when a memory capacity available to be used as the second memory region 122 becomes insufficient within the operational memory 120. For example, when all the memory usage ratios of the respective processors PRC1 to PRC4 are high and thus most or all of the operational memory 120 is being used as the first memory region 121, the data may be directly moved to the non-volatile memory 130.

For example, the first mode swap condition for performing the first mode swap operation may be satisfied when a resource required for the first mode swap operation is sufficient, e.g., when a transmission network between the operational memory 120 and the non-volatile memory 130 is sufficient. For example, It may be determined that the transmission network is sufficient when the transmission network is not in use to perform other operations and/or when other operations to be performed by using the transport network are not waiting. In other words, when a performance degradation of the data processing system 100 does not occur, the first mode swap operation may be performed.

When the first mode swap condition is not satisfied, the memory controller 110 may perform the second mode swap operation. The second mode swap operation may include the first swap operation and the second swap operation respectively illustrated in FIGS. 4A and 4B. The memory controller 110 may complete the second mode swap operation by performing the second swap operation when the second swap condition is satisfied after completion of the first swap operation. Even before performing the second swap operation, the memory controller 110 may release the assignment of the swap memory area SWM when the first swap operation is completed.

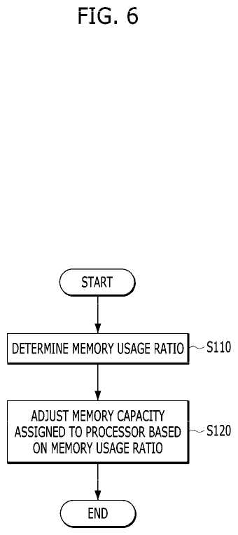

FIG. 6 shows an operation by which the memory controller 110 of FIG. 1 adjusts memory capacities assigned to the processors PRC1 to PRC4, in accordance with an embodiment.

Referring to FIG. 6, in step S110, the memory controller 110 may determine the memory usage ratios of the respective processors PRC1 to PRC4. Particularly, the memory controller 110 may determine memory usage ratios of the respective processors PRC1 to PRC4 based on information of the memory usage amounts received from the respective processors PRC1 to PRC4, the memory capacities assigned to the respective processors PRC1 to PRC4, and the internal memory capacities included in the respective processors PRC1 to PRC4.

In step S120, the memory controller 110 may adjust the memory capacities assigned to the respective processors PRC1 to PRC4 based on the determined memory usage ratios of the respective processors PRC1 to PRC4. For example, the memory controller 110 may determine to increase the memory capacity assigned to a processor when the memory usage ratio of the processor becomes greater than the first threshold value. For example, the memory controller 110 may determine to decrease the memory capacity assigned to a processor when the memory usage ratio of the processor becomes less than the second threshold value. The memory controller 110 may release the assignment of the swap memory area SWM assigned to a processor to decrease the memory capacity assigned to the processor.

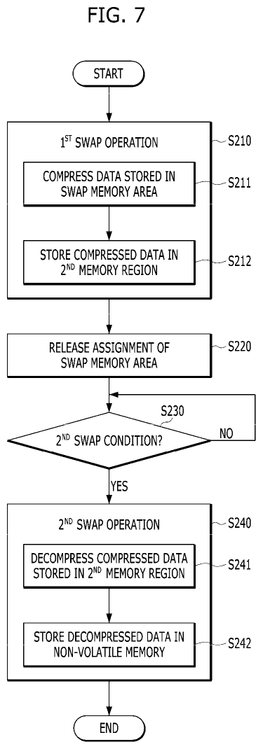

FIG. 7 shows an operation by which the memory controller 110 of FIG. 1 releases the assignment of the swap memory area, in accordance with an embodiment.

Referring to FIG. 7, in step S210, the memory controller 110 may perform the first swap operation on the swap memory area SWM. The memory controller 110 may perform the first swap operation of moving data from the swap memory area SWM to the second memory region 122.

Particularly, in step S211, the memory controller 110 may compress the data stored in the swap memory area SWM.

In step S212, the memory controller 110 may store the compressed data into the second memory region 122 within the operational memory 120.

In step S220, the memory controller 110 may release the assignment of the swap memory area SWM.

In step S230, the memory controller 110 may determine whether the second swap condition is satisfied. For example, the memory controller 110 may determine that the second swap condition has been satisfied when the memory controller 110 determines to expand the first memory region 121 by incorporating the second memory region 122 into the first memory region 121. For example, the memory controller 110 may determine that the second swap condition has been satisfied when a resource required for the second swap operation is sufficient. Step S230 may be repeated when the second swap condition is not satisfied. The process may proceed to step S240 when the second swap condition is satisfied.

In step S240, the memory controller 110 may perform the second swap operation. The memory controller 110 may perform the second swap operation of moving the data from the second memory region 122 to the non-volatile memory 130.

Particularly, in step S241, the memory controller 110 may decompress the compressed data stored in the second memory region 122.

In step S242, the memory controller 110 may store the decompressed data into the non-volatile memory 130.

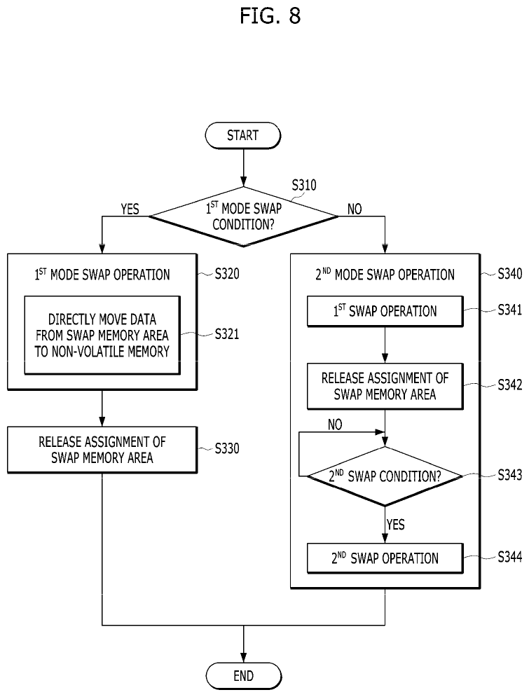

FIG. 8 shows an operation by which the memory controller 110 of FIG. 1 releases the assignment of the swap memory area SWM, in accordance with an embodiment.

Referring to FIG. 8, in step S310, the memory controller 110 may determine whether the first mode swap condition is satisfied. The process may proceed to step S320 when the first mode swap condition is satisfied and may proceed to step S340 when the first mode swap condition is not satisfied.

In step S320, the memory controller 110 may perform the first mode swap operation.

Particularly, in step S321, the memory controller 110 may move data from the swap memory area SWM directly to the non-volatile memory 130 without using the second memory region 122.

In step S330, the memory controller 110 may release the assignment of the swap memory area SWM.

In step S340, the memory controller 110 may perform the second mode swap operation.

Particularly, in step S341, the memory controller 110 may perform the first swap operation on the swap memory area SWM. Step S341 may be performed substantially the same way as step S210 illustrated in FIG. 7.

In step S342, the memory controller 110 may release the assignment of the swap memory area SWM.

In step S343, the memory controller 110 may determine whether the second swap condition is satisfied.

In step S344, the memory controller 110 may perform the second swap operation. Step S344 may be performed substantially the same way as step S240 illustrated in FIG. 7.

While certain embodiments have been described above, it will be understood to those skilled in the art that the embodiments described are by way of example only. Accordingly, the data processing system should not be limited based on the described embodiments. Rather, the data processing system described herein should only be limited in light of the claims that follow when taken in conjunction with the above description and accompanying drawings.

What is claimed is:

1. A data processing system comprising:
a plurality of processors;
a memory including a first memory region and a second memory region;
a non-volatile memory; and
a memory controller configured to:
perform a first swap operation of releasing assignment of a memory area assigned to a first processor within the first memory region, the first swap operation performed by moving data from the memory area to the second memory region; and
perform a second swap operation by moving the data from the second memory region to the non-volatile memory when a second swap condition is satisfied after completion of the first swap operation.

2. The data processing system of claim 1, wherein the memory controller releases the assignment of the memory area before performing the second swap operation when the first swap operation is completed.

3. The data processing system of claim 1, wherein the memory controller performs the first swap operation by compressing the data stored in the memory area and storing the compressed data in the second memory region.

4. The data processing system of claim 3, wherein the memory controller performs the second swap operation by decompressing the compressed data stored in the second memory region and storing the decompressed data in the non-volatile memory.

5. The data processing system of claim 1, wherein the memory controller determines that the second swap condition has been satisfied based on the memory controller determining to expand the first memory region by incorporating the second memory region into the first memory region.

6. The data processing system of claim 1, wherein the memory controller determines the second swap condition has been satisfied when a resource required for the second swap operation is sufficient.

7. The data processing system of claim 1, wherein the memory controller assigns, to the processors, memory areas divided from the first memory region and adjusts memory capacities assigned to the respective processors based on memory usage ratios of the respective processors.

8. The data processing system of claim 7, wherein the memory controller determines the memory usage ratios of the respective processors based on information of memory usage amounts received from the respective processors, memory capacities assigned to the respective processors, and internal memory amounts included in the respective processors.

9. The data processing system of claim 1, wherein the memory controller comprises code or circuitry configured to move, when a predetermined condition is satisfied, the data from the memory area to the non-volatile memory without using the second memory region for releasing the assignment of the memory area, the code or circuitry configured to be executed as an alternative to performing the first swap operation and the second swap operation.

10. A data processing system comprising:
a plurality of processors;
an operational memory including a first memory region and a second memory region; and
a memory controller configured to perform a first swap operation of releasing assignment of a memory area assigned to a first processor within the first memory region, the first swap operation performed by compressing data stored in the memory area and storing the compressed data into the second memory region.

11. The data processing system of claim 10, wherein the memory controller performs a second swap operation after completion of the first swap operation, the second swap operation performed by moving the compressed data from the second memory region to a non-volatile memory.

12. The data processing system of claim 11, wherein the memory controller releases, before performing the second swap operation, the assignment of the memory area when the first swap operation is completed.

13. The data processing system of claim 11, wherein the memory controller performs the second swap operation by decompressing the compressed data stored in the second memory region and storing the decompressed data into the non-volatile memory.

14. The data processing system of claim 11, wherein the memory controller performs the second swap operation when the memory controller determines to expand the first memory region by incorporating the second memory region into the first memory region.

15. The data processing system of claim 11, wherein the memory controller performs the second swap operation when a resource required for the second swap operation is sufficient.

16. The data processing system of claim 11, wherein the memory controller comprises code or circuitry configured to move, when a predetermined condition is satisfied, the data from the memory area to the non-volatile memory without using the second memory region for releasing the assignment of the memory area, the code configured to be executed as an alternative to performing the first swap operation and the second swap operation.

17. The data processing system of claim 10, wherein the memory controller assigns, to the processors, memory areas divided from the first memory region and adjusts memory capacities assigned to the respective processors based on memory usage ratios of the respective processors.

18. A data processing system comprising:
a plurality of processors;
a memory including a first memory region and a second memory region;
a non-volatile memory; and
a memory controller configured to perform, for releasing assignment of a memory area within the first memory region assigned to a first processor, a first mode swap operation or a second mode swap operation according to a first mode swap condition,
wherein the memory controller performs the second mode swap operation by temporarily moving data from the memory area to the second memory region and by moving the data from the second memory region to the non-volatile memory, and
wherein the memory controller performs the first mode swap operation by moving the data from the memory area to the non-volatile memory without using the second memory region.

19. The data processing system of claim 18, wherein the memory controller determines the first mode swap condition to be satisfied when a memory capacity available to be used as the second memory region becomes insufficient within the operational memory.

20. The data processing system of claim 18,
wherein the memory controller performs, during the second mode swap operation, a first swap operation by moving the data from the memory area to the second memory region and a second swap operation by moving the data from the second memory region to the non-volatile memory, and
wherein the memory controller releases, before performing the second swap operation, the assignment of the memory area when the first swap operation is completed.
